(19) United States
(12) Patent Application Publication
(10) Pub. No.: US 2009/0037609 A1
(43) Pub. Date: Feb. 5, 2009

(54) MIDDLE MANAGEMENT OF INPUT/OUTPUT IN SERVER SYSTEMS

(76) Inventors: Dwight D. Riley, Houston, TX (US); James X. Dinh, Austin, TX (US); Barry S. Basile, Houston, TX (US); Kenneth A. Jansen, Magnolia, TX (US); Hubert E. Brinkmann, Spring, TX (US); David L. Matthews, Cypress, TX (US); Paul V. Brownell, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/830,747

(22) Filed: Jul. 30, 2007

(51) Int. Cl. G06F 3/00

(52) U.S. Cl. 710/10

(57) ABSTRACT

A middle manager and methods are provided to enable a plurality of host devices to share one or more input/output devices. The middle manager initializes each shared input/output device and binds one or more functions of each input/output device to a specific host node in the system, such that hosts may only access functions to which they are bound. The middle manager may also utilize a configuration register map to translate values from the actual configuration register into a unique modified value for each of the plurality of host devices such that each host device may access and use the shared input/output device regardless of the firmware or operating system operating thereon.

### BACKGROUND

In some systems, such as a server system, a complete set of input/output (“I/O”) devices are provided for each blade, though the I/O devices may not be fully utilized. Unutilized or underutilized I/O devices result in unnecessary cost at the system level. Yet, in attempting to share an I/O device between a plurality of hosts, multiple host platforms may attempt to configure the same physical I/O device (i.e., write to or read from configuration registers). When two or more hosts attempt to share the same I/O device, the written and read values of the configuration registers may conflict as between the two or more hosts.

### BRIEF DESCRIPTION OF THE DRAWINGS

For a detailed description of exemplary embodiments of the invention, reference will now be made to the accompanying drawings in which:

FIG. 1 shows a block diagram of a blade server system in accordance with embodiments of the present disclosure;

FIG. 2 shows a flowchart of a method for initialization and enumeration of the blade server system in accordance with embodiments of the present disclosure; and

FIG. 3 shows a flowchart of a method for data translation between host devices and shared multi-function I/O devices in a blade server system in accordance with embodiments of the present disclosure.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described above, server blade systems may include a complete set of I/O devices on each blade, some or all of which may be unutilized or underutilized. In accordance with various embodiments, multiple server blades share one or more I/O devices resulting in system level savings. In various embodiments, sharing is enabled in a fashion that does not necessitate change to existing available drivers, thereby rendering the sharing transparent to the end user. Sharing of I/O resources among server blade systems is enabled in at least some embodiments without adding additional specialized hardware to the I/O devices.

When multiple host platforms are attempting to configure such a shared I/O device, however, the values written to and read from the configuration registers of the shared I/O device may be in conflict as between the multiple hosts. According to the present disclosure, an independent management processor can define methods used to translate incorrect data values to correct ones, resulting in a configuration that is simultaneously acceptable to the multiple hosts. The methods of the management processor additionally may be beneficially used to modify, in-flight, the data values written to registers of an I/O device in order to work around defects in the silicon, configuration firmware or operating system driver.

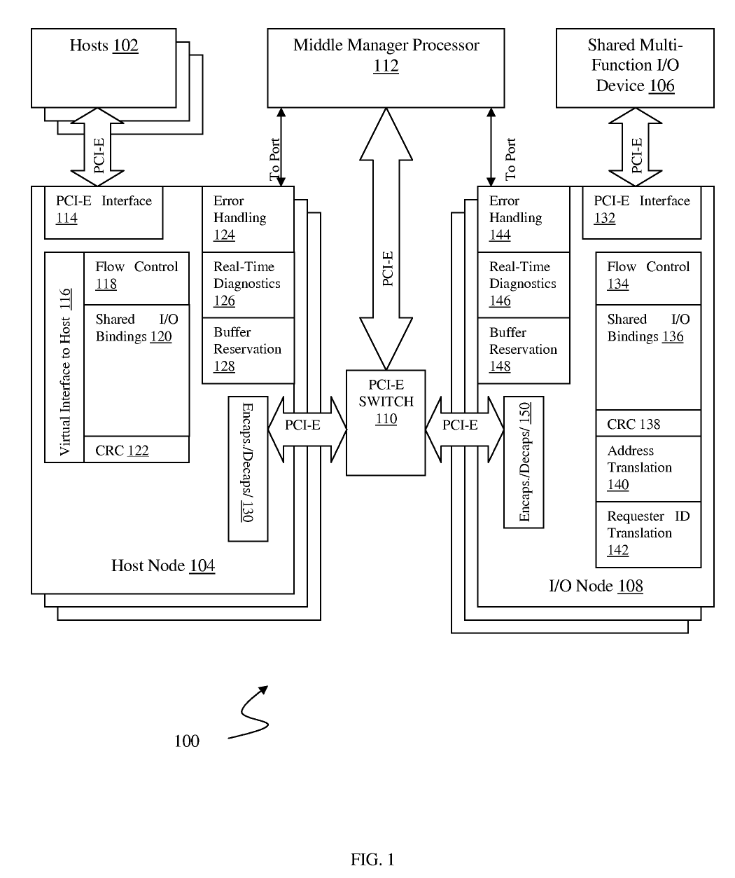

Referring now to FIG. 1, a blade server system 100 is shown. The system 100 includes at least a host device 102 with a host node 104 coupled to a shared multi-function I/O device 106 via an I/O node 108. A Peripheral Component Interconnect Express (“PCI-E”) fabric may be used to couple the host 102, host node 104, and shared I/O device 106 and I/O node 108, where the fabric connects the devices and nodes to a PCI-E switch 110. In various embodiments, the illustrative host 102 represents a plurality of hosts and the illustrative I/O device 106 represents a plurality of such devices. The I/O device 106 may comprise a storage device, a network interface controller, or other type of I/O device.

The multi-function I/O device 106 is shared between a plurality of host devices (shown illustratively by host 102) as a set of independent devices. The system 100 is managed by the middle manager processor 112. The middle manager processor 112 may comprise a dedicated subsystem or be a node that is operable to take control of the remainder of the system. The middle manager processor 112 initializes the shared multi-function I/O device 106 by applying configuration settings in the typical fashion, but accesses the system at the “middle,” facilitated by PCI-E switch 110. The middle manager processor 112 then assigns, or binds, particular I/O functions to a specific host node or leaves a given function unassigned. In doing so, the middle manager processor 112 prevents host nodes that are not bound to a specific I/O device and function from “discovering” or “seeing” the device during enumeration, as will be described further below. The bindings, or assignments of functions, thus steer signals for carrying out functions to the appropriate host node. Interrupts, and other host specific interface signals, may be assigned or bound to specific hosts based on values programmed in a block of logic to assist in proper steering of the signals.

The host node 104 includes a PCI-E Interface 114 that couples the host node 104 to the host 102, a virtual interface 116 to the host, End-to-End flow control 118 that monitors data packet flow across the PCI-E fabric, and shared I/O bindings 120 (i.e., specific functions) that stores a map of each function of the I/O device 106 to a specific host. The host node 104 also includes end-to-end Cyclic Redundancy Code 122 (“CRC”) for error correction. The host node 104 also includes error handling 124 that generates flags upon detection of an error, real-time diagnostics 126 for detecting errors, and a Flow Control Buffer Reservation 128 that stores the credits allocated for traffic across the PCI-E fabric. The host node 104 also includes an encapsulator/decapsulator 130 that processes packets traversing the PCI-E fabric to the host node 104.

The I/O node 108 includes a PCI-E Interface 132 that couples the I/O node 108 to the I/O device 106, End-to-End flow control 134 that monitors data packet flow across the PCI-E fabric, and shared I/O bindings 136 (i.e., specific functions) that stores a map of each function of the I/O device 106 to a specific host. The I/O node 108 also includes end-to-end Cyclic Redundancy Code 138 for error correction. The I/O node 108 also includes an address translation map 140 that stores modified configuration register values for each value in actual configuration registers, such that a modified configuration exists for each host in the system. The modified configuration may consist of values that are simply substituted for the configuration read from the actual registers, or a mask that applies a logical operation, such as “AND,” “OR,” or exclusive OR “XOR”) with a mask value to modify the values read from the actual registers. The I/O node 108 also includes a requester ID translation unit 142 that provides, based on which host requests the configuration register data values, the modified value identified for that particular host in the address translation 140. The I/O node 108 also includes error handling 144 that generates flags upon detection of an error, real-time diagnostics 146 for detecting errors, a Flow Control Buffer Reservation 148 that stores the credits allocated for traffic across the PCI-E fabric. The I/O node 108 also includes an encapsulator/decapsulator 148 that processes packets traversing the PCI-E fabric to the I/O node 108.

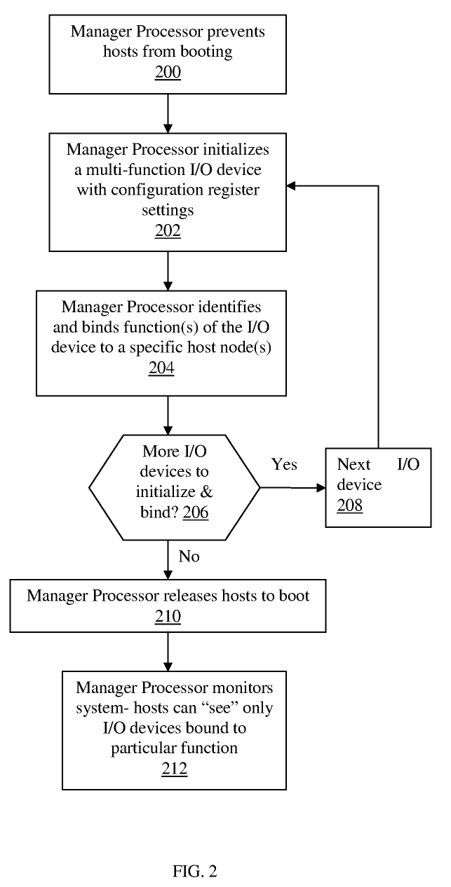

Referring now to FIG. 2, a flowchart is shown for a method for initialization and enumeration of the blade server system in accordance with FIG. 1. The method begins with the middle manager processor 112 preventing hosts from booting during initialization of any multi-function I/O devices. In block 202, the middle manager processor 11 2 initializes a first multi-function I/O device with configuration register settings. In some embodiments, the initialization is in accordance with well-known practices in the field for initializing the settings of an I/O device in such a system.

In block 204, the middle manager processor 112 configures the “middle” of the system by identifying one or more functions, and assigning each function to a specific host node in the system 100. In some embodiments, one or more functions, if not intended for use, may be left unassigned for later assignment as needed. At block 206, a determination is made as to whether there are additional I/O devices to initialize and bind functions to specific host nodes, as in some embodiments of systems of FIG. 1, a plurality of I/O devices may be employed. The assignments are stored at both the host node 104 in the shared I/O bindings 120 and the I/O node 108 in the shared I/O bindings 136.

If there are a plurality of I/O devices, at 208, the method continues by repeating, as described above, initialization for the next I/O device (at 208), returning to block 202 for each additional I/O device. If each multi-function I/O device in the system is initialized and the functions for each are bound to a specific host node (or intentionally left unassigned), the middle manager processor releases the hosts to boot (block 210), and during boot, each host device enumerates the I/O device(s) to which it has access. The middle manager processor continues to monitor the system (block 212), and each host can “see” and make use of the I/O devices to which it was bound functionally during initialization.

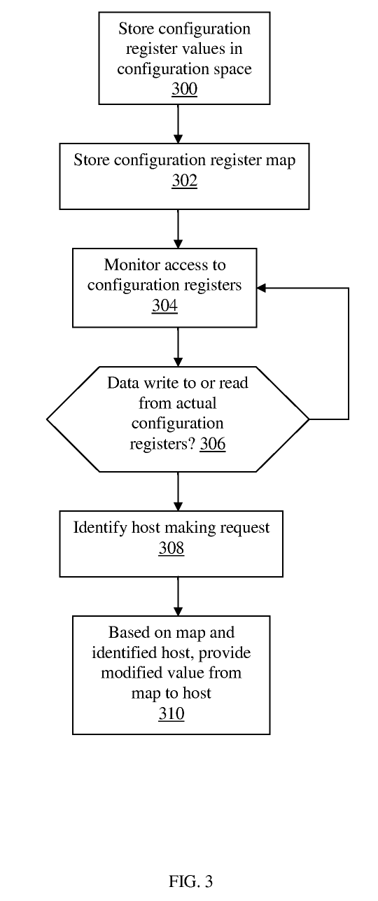

With such initialization complete, a plurality of hosts may operably share a single multi-function I/O device, or likewise share a plurality of multi-function I/O devices, each one dedicated to particular functions. In operation, however, each host may require access to and from the configuration register values, and each host may have differing firmware or operating system software relative to other hosts in the same system. In order to make the configuration register values universally useable for each host, the following method may be implemented. Referring now to FIG. 3, a flowchart is shown for a method for data translation between host devices and shared multi-function I/O devices in a blade server system in accordance with FIG. 1.

The method begins with storing the configuration register values in the configuration space (block 300) which may be included as part of the initialization described above. In various embodiments, there resides a configuration space in the PCI-E fabric between the PCI-E switch 110 and the encapsulator/decapsulator 130 and 150 of the nodes 104 and 108 respectively.

The method continues with storing a configuration register map (block 302). The map of the configuration register space is made visible to the middle manager processor 112 such that the middle manager processor 112 is able to write values to the map to cause address-associated data read from or written to the actual configuration registers to be replaced with a modified value based on the identity of the requesting host.

The method proceeds with monitoring access to the configuration registers of the I/O device by any given host device (block 304). At 306, a determination is made as to whether data is being written to or read from the actual configuration registers. If not, the method continues with further monitoring at block 304. If data is being written to or read from the actual configuration registers, then at block 308, the host making the request is identified (distinguishing the requesting host from other hosts in the system), and based on the map and the identified requesting host, a modified value from the map is provided to the host. Specifically, the modified value may consist of a simple substituted value for the configuration register value (or even for an entire range of addresses), or may be achieved by applying a logical operation, such as “AND,” “OR,” or exclusive “XOR” with a mask value defined by the map. The mask value and type of modification applied may be defined, in various embodiments, on a per-address location basis. By providing a modified value for the configuration registers depending on the identity of the requesting host, each host in the system perceives a customized configuration setting of the same shared I/O device in a fashion that is transparent to the remainder of the hosts and without interfering with the use of the shared I/O device by the remainder of the hosts.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a plurality of host devices operably coupled to a switch via a fabric;
at least one input/output device operably coupled to the switch via the fabric, wherein the input/output device is shared by the plurality of host devices; and
a middle manager processor operably coupled to the switch to manage shared use of the input/output device by the plurality of host devices;
wherein the middle manager binds one or more functions of the input/output device to one or more specific host nodes such that each host device accesses functions of the input/output device to which it is bound.

2. The system according to claim 1, wherein the middle manager initializes the at least one input/output device with configuration register values and prevents the plurality of hosts from booting until each input/output device is initialized.

3. The system according to claim 2, further comprising configuration space that stores the configuration register values.

4. The system according to claim 3, further comprising a configuration register map used by the middle manager to translate the configuration register values into a unique modified value for each one of the plurality of hosts based on which of the plurality of hosts requests access to the input/output device.

5. The system according to claim 4, wherein the configuration register map stores a substitute value or range of values to produce a unique modified value for each one of the plurality of hosts.

6. The system according to claim 4, wherein the configuration register map stores a mask value that is applied by a logical function to the value or range of values from the configuration register values to produce a unique modified value for each one of the plurality of hosts.

7. The system according to claim 1, wherein the system comprises a blade server system.

8. A management device, comprising:
means to detect at least one input/output device operably coupled via a fabric to a switch for access by a plurality of host devices
means to initialize the at least one input/put device with configuration register values; and
means to bind one or more functions of the input/output device to a specific host node for each function.

9. The management device according to claim 8, further comprising means to prevent the plurality of host devices from booting during initialization and binding functions of the input/output device.

10. The management device according to claim 8, further comprising means to release the plurality of host devices to boot once input/output devices are initialized and one or more functions are bound

11. The management device according to claim 8, further comprising filtering means to monitor access to the configuration registers of the input/output device by any host device and detecting access to the configuration register values by any of the plurality of host devices.

12. The management device according to claim 11, further comprising a configuration register map that maps a unique modified value to each of the plurality of host devices; wherein the management device translates the accessed value from the configuration register into a unique modified value based on the identity of requesting host device and provides the unique modified value to requesting host.

13. The management device according to claim 8, further comprising translation logic to read a configuration register map and provide a modified value

14. A method, comprising:
detecting at least one input/output device operably coupled via a fabric to a switch for access by a plurality of host devices;
initializing the at least one input/put device with configuration register values; and
binding one or more functions of the input/output device to a specific host node for each function.

15. The method according to claim 14, further comprising preventing the plurality of host devices from booting during initialization and binding functions of the input/output device.

16. The method according to claim 14, further comprising releasing the plurality of host devices to boot once input/output devices are initialized and one or more functions are bound.

17. The method according to claim 14, further comprising:
monitoring access to the configuration register values of the input/output device by any of the plurality of host devices;
upon detecting access to the configuration register values by any of the plurality of host devices, identifying the requesting host device;
translating the accessed value from the configuration register into a unique modified value based on the identified requesting host device; and
providing the unique modified value to requesting host.

18. The method according to claim 17, wherein translating further comprises:
retrieving the accessed value from the configuration register;
referencing a configuration register map; and
based on the identified requesting host device, selecting the unique modified value for the requesting host device from the configuration register map.

19. The method according to claim 18, wherein the configuration register map stores a substitute value or range of values to produce a unique modified value for each one of the plurality of hosts.

20. The method according to claim 18, wherein the configuration register map stores a mask value that is applied by a logical function to the value or range of values from the configuration register values to produce a unique modified value for each one of the plurality of hosts.
